(19) United States
(12) Patent Application Publication
(10) Pub. No.: US 2006/0210347 A1
(43) Pub. Date: Sep. 21, 2006

(54) Sheet processing apparatus, sheet processing method for implementing the apparatus, and program

(75) Inventor: Hiroyasu Kurashina, Matsumoto-shi (JP)

Correspondence Address: HOGAN & HARTSON L.L.P., 500 S. GRAND AVENUE, SUITE 1900, LOS ANGELES, CA, 90071-2611, US

(73) Assignee: SEIKO EPSON CORPORATION

(21) Appl. No.: 11/354,323

(22) Filed: Feb. 14, 2006

(30) Foreign Application Priority Data
Mar. 16, 2005 (JP) 2005-076059

(51) Int. Cl. B41J 29/00; B41J 11/66

(52) U.S. Cl. 400/719; 400/621

(57) ABSTRACT

A sheet processing apparatus that applies a clip-out process of clipping out a desired character from a process sheet that configures a cutting sheet with a peeling sheet attached on a rear side, and a printing process of printing a pattern to a clip-out region of a clipping as a result of the clip-out process. The sheet processing apparatus includes: a clip-out device that clips out the character from the process sheet of the cutting sheet while feeding the cutting sheet in a direction opposite to normal based on the character; and a printing device that prints a pattern to the clip-out region of the character that is clipped out from the process sheet. In the sheet processing apparatus, the printing device prints the pattern to make the pattern go beyond a cutting line of the character.

The entire disclosure of Japanese Patent Application No. 2005-076059, filed Mar. 16, 2005, is expressly incorporated by reference herein.

### BACKGROUND

1. Technical Field

The present invention relates to a sheet processing apparatus that clips out any desired character from a cutting sheet, and a sheet processing method for implementing the apparatus and a program.

2. Related Art

A sheet processing apparatus of a well known type performs printing to the front side surface of a process sheet, and clips out the process sheet in the desired shape. The process sheet is attached with a peeling sheet on its rear side so that a cutting sheet is configured. For such a sheet processing apparatus, refer to Patent Document 1, for example (JP-A-2004-114210). This sheet processing apparatus is configured by two mechanisms of printing and clipping, and thus any printed portion of a process sheet can be clipped in a desired shape, for example.

Considered here is a feasible case that the sheet processing apparatus applies decorative printing such as dry offset printing to a clip-out region of a process sheet. In such a case, however, a concern arises about a possible displacement, even though very small, observed between a clip-out region that is to be clipped out by the clipping mechanism and a printed region that has been printed by the printing mechanism. Such a displacement is often observed in a boundary area between a clip-out region and a no-clip-out region. If this is the case, any not-printed region that is identified as a no-clip-out region by the printing mechanism may be clipped out by the clipping mechanism as is identified as a clip-out region. This is resulted from the configuration that the printing mechanism and the clipping mechanism are controlled by each different motor. The resulting clipping thus does not look good, partially printed but partially not printed.

### SUMMARY

An advantage of some aspects of the invention is to provide a sheet processing apparatus that is capable of printing a pattern entirely to a clip-out region of a process sheet, and a sheet processing method for implementing the apparatus and a program.

An aspect of the invention is directed to a sheet processing apparatus that applies a clip-out process of clipping out a desired character from a process sheet that configures a cutting sheet with a peeling sheet attached on a rear side, and a printing process of printing a pattern to a clip-out region of a clipping as a result of the clip-out process. The sheet processing apparatus includes: a clip-out device that clips out the character from the process sheet of the cutting sheet while feeding the cutting sheet in a direction opposite to normal based on the character; and a printing device that prints a pattern to the clip-out region of the character that is clipped out from the process sheet. In the sheet processing apparatus, the printing device prints the pattern to make the pattern go beyond a cutting line of the character.

A second aspect of the invention is directed to a sheet processing method for implementing a sheet processing apparatus that applies a clip-out process of clipping out a desired character from a process sheet that configures a cutting sheet with a peeling sheet attached on a rear side, and a printing process of printing a pattern to a clip-out region of a clipping as a result of the clip-out process. The sheet processing method includes: clipping out the character from the process sheet of the cutting sheet while feeding the cutting sheet in a direction opposite to normal based on the character; and printing a pattern to the clip-out region of the character that is clipped out from the process sheet to make the pattern go beyond a cutting line of the character.

With such configurations, in the process of printing a pattern to a clip-out region, the pattern is so printed as to go beyond a cutting line of a clipping that is the clipped-out result derived by the clip-out process. In such a manner, the pattern is printed not only entirely to the clip-out region but also over to a no-clip-out region therearound. Accordingly, even if some displacement is observed between a clip-out region that is to be clipped out by the clipping mechanism and a printed region that has been printed by the printing mechanism, the resulting clipping can be entirely printed with a pattern.

If this is the case, the printing device can print the pattern in various pattern forms, and the sheet processing apparatus preferably includes a pattern form specification device that specifies the pattern by form for printing.

Such a configuration enables to print a much wider variety of patterns to the clip-out region of the process sheet, meeting users' needs and wants.

The pattern form specification device preferably makes a specification on the basis of the character.

When a plurality of characters are to be clipped-out, such a configuration enables to print patterns of each different form on the basis of character, meeting users' needs and wants.

A third aspect of the invention is directed to a program for use with a computer, characterized in being operable to instruct the computer to serve as the devices in any one of the sheet processing apparatuses above.

This favorably provides a program for printing a clip-out region of a process sheet entirely with a pattern.

### BRIEF DESCRIPTION OF THE DRAWINGS

The invention will be described with reference to the accompanying drawings, wherein like numbers reference like elements.

FIG. 1 is an external perspective view of a tape processing apparatus with a lid closed.

FIG. 2 is a cross sectional view of the tape processing apparatus.

FIG. 3 is a control block diagram of the tape processing apparatus.

FIG. 4 is a diagram for illustrating the operation procedure of a clip-out process.

FIG. 5 is a diagram for illustrating the operation procedure for pattern printing to a clip-out region.

FIGS. 6A and 6B are both a diagram showing a printing region to be printed with a pattern.

FIG. 7 is a diagram for illustrating other exemplary operation procedure for pattern printing.

FIGS. 8A and 8B are both a diagram showing an exemplary tape piece created by the tape processing device.

### DESCRIPTION OF EXEMPLARY EMBODIMENTS

In the below, by referring to the accompanying drawings, an embodiment of a sheet processing apparatus, a sheet processing method for implementing the apparatus, and a program of the invention is described, specifically about an exemplary case that the embodiment is applied to a tape processing apparatus, which is of a type processing a cutting tape in a tape cartridge. The tape processing apparatus subjects a cutting tape to a printing process while dispensing the tape from its cartridge. The cutting tape here is the one configured by a process tape and a peeling tape. After the printing process, the tape processing apparatus cuts out the printed portion of the tape by executing a full-cut process thereto, and then a cutting process to the resulting clipping piece so that the resulting tape piece forms a so-called cut-out letter (symbol and graphic included).

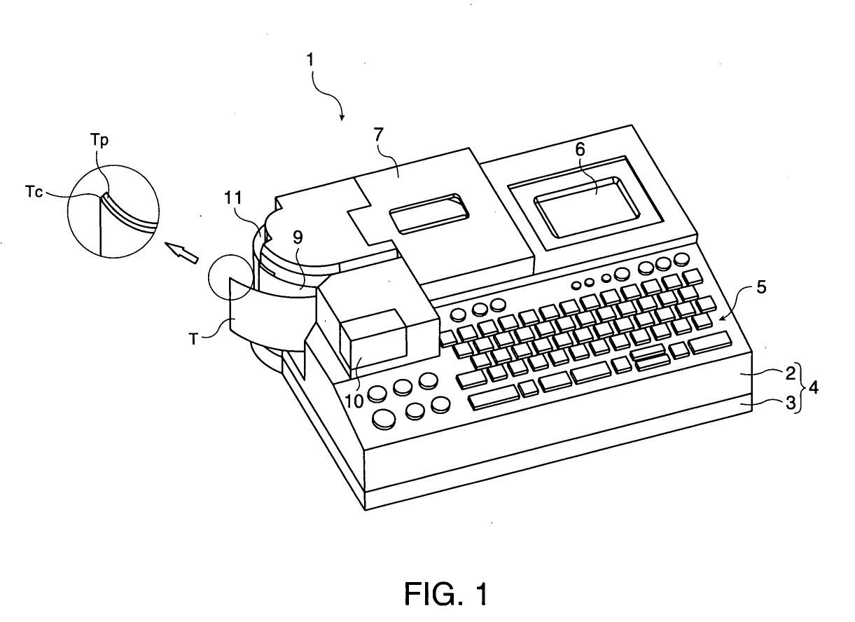

FIG. 1 is an external perspective view of a tape processing apparatus 1. As shown in the drawing, the tape processing apparatus 1 has the outer case of a apparatus case 4, which is configured by an upper case 2 and a lower case 3. The upper case 2 carries on its front upper surface a keyboard 5 including a plurality of keys for various data input. On the rear upper surface of the upper case 2, a display 6 is incorporated on the right side. The display 6 is adjacent, on the left side in the drawing, with a cartridge lid 7 that freely opens and closes. Beneath the cartridge lid 7, a cartridge attachment portion 8 is formed for attachment/detachment of a cartridge C. On the left side surface of the upper case 2, formed is a tape ejection port 9 for ejecting a cutting tape T after processing.

In FIG. 1, a reference numeral 10 denotes a tool exchange lid for exchange of a cutting tool 64 for use in the cutting process. A reference numeral 11 denotes a housing portion lid for use to open a tape housing section 61 (will be described later) serving as a tape buffer in the cutting process.

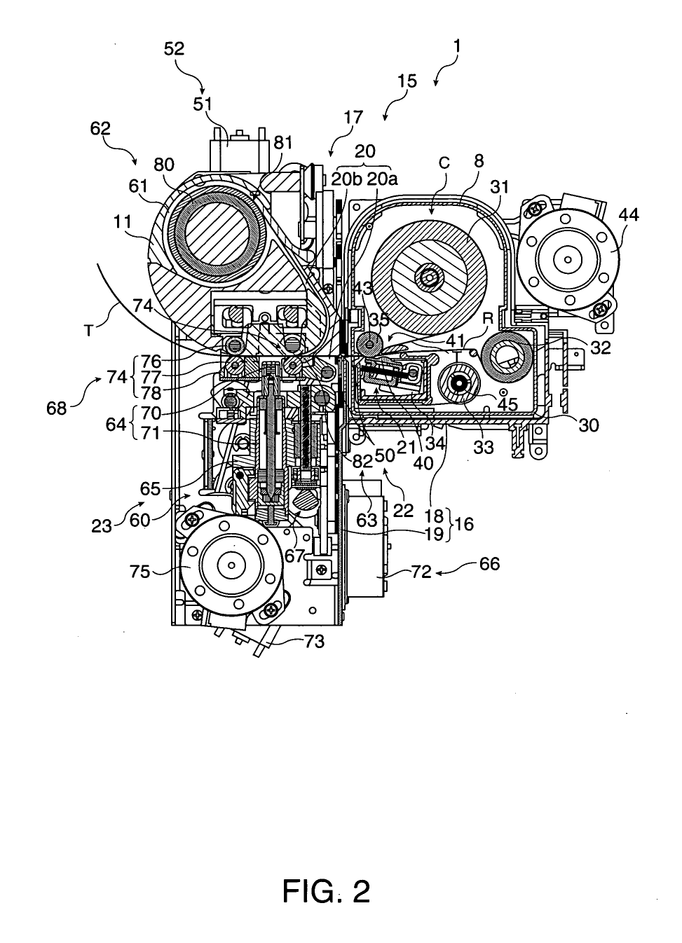

As shown in FIG. 2, the apparatus case 4 includes therein a apparatus assembly unit 15, which is configured to include a support frame 16, and an internal apparatus 17. The support frame 16 is fixed to the apparatus case 4, and the internal apparatus 17 is incorporated in the support frame 16. The support frame 16 includes a cartridge frame 18 configuring the cartridge attachment section 8, and as an accessory element thereof, a common support frame 19.

The support frame 16 and the apparatus case 4 form a tape feeding path 20 for forwarding the cutting tape T dispensed from the cartridge C. As shown in FIG. 2, the tape feeding path 20 is configured by a first feeding path 20a, and a second feeding path 20b. Specifically, the first feeding path 20a is formed linearly from a tape dispenser port (will be described later) of the cartridge C to the tape ejection slot 9. The second feeding path 20b branches from the first feeding path 20a in a substantially perpendicular direction, and is linked to the tape housing section 61.

As shown in FIG. 2, the internal apparatus 17 is configured to include a printing unit 21, a full-cut unit 22, a cutting unit 23, and a control unit 24 (not shown). More in detail, the printing unit 21 is incorporated in the cartridge frame 18, and applies a printing process to the cutting tape T. The full-cut unit 22 is supported by the common support frame 19 so as to face toward the tape feeding path 20, and applies a full-cut process to the cutting tape T. The cutting unit 23 is supported by the common support frame 19 on the downstream side of the full-cut unit 22, and applies a cutting process to the cutting tape T, i.e., tape piece. The control unit 24 is exercises control collectively over these units.

In the tape processing apparatus 1 of such a configuration, the printing unit 21 applies the printing process to the cutting tape T based on the control exercised by the control unit 24. Thereafter, the full-cut unit 22 and the cutting unit 23 respectively execute the full-cut process and the cutting process in order so that a tape piece T1 is derived. The tape piece T1 is printed with any desired character, and is cut in any desired shape.

As shown in FIG. 2, the cartridge C used in the tape processing apparatus 1 is entirely covered by a cartridge case 30, and is configured to include a tape reel 31, a ribbon dispenser reel 32, and a ribbon take-up reel 33. More specifically, the tape reel 31 is of the cutting tape T in a roll. The ribbon dispenser reel 32 is of an ink ribbon R also in a roll, and the ribbon take-up reel 33 takes up the ribbon R coming therefrom. The cartridge C is formed with a through aperture 34 through which a printing head 40 of the printing head 21 (will be described later) goes with some play. In such a manner as to face the through aperture 34, a rotatable platen roller 35 is disposed to stand.

The cutting tape T is facing the through aperture 34, and the tip thereof is exposed to the outside of the cartridge C, i.e., the tape feeding path 20, by being pulled out from a tape dispenser port (not shown) that is formed in the vicinity of the through aperture 34. The ink ribbon R is overlaid together with the cutting tape T at the through aperture 34, and then goes around the through aperture 34 and is taken up by the ribbon take-up reel 33.

In this example, the cutting tape T has an adhesive surface and is specifically for cut-out letters, and is a multilayer of a process tape Tc and a peeling tape Tp. The process tape Tc is subjected to printing and clip-out processes, and after the processes, the resulting cut-out letter(s) is adhesive. The cartridge C carries a plurality of such cutting tapes T varying in base color and width, and is provided with a plurality of identification holes (not shown) on its underside for identifying the cutting tape T by type.

On the other hand, the cartridge attachment section 8 is provided, on its base plate, with a tape identification sensor 36 (not shown). When the cartridge C is set to the cartridge attachment section 8, the tape identification sensor 36 accordingly identifies the cutting tape T by type based on the configuration of the identification holes, i.e., bit pattern, provided to the underside of the cartridge C.

The cartridge attachment section 8 is so configured as to accommodate also a cartridge of a label tape. Using the tape processing apparatus 1, the label tape is printed and then cut so that the resulting tape piece is adhesive. The tape identification sensor 36 is also capable of detecting whether the attached cartridge C is for cut-out letters or for label use, i.e., detecting the type of tape in the cartridge.

Described next are units provided to the internal apparatus 17. As shown in FIG. 2 the printing unit 21 performs printing while dispensing and forwarding the cutting tape T from the cartridge C. The printing unit 21 is configured to include a printing head (thermal head) 40, and a printing feed mechanism 41, which dispenses the cutting tape T from the cartridge C, and forwards the tape along the tape feeding path 20.

The printing head 40 is disposed to stand at the cartridge attachment section 8 while being covered by a head cover. When the cartridge C is set to the cartridge attachment section 8, the printing head 40 is inserted with some play into the through aperture 34 of the cartridge C. After such insertion, the printing head 40 is opposed to the platen roller 35 through the cutting tape T and the ink ribbon R both at the through aperture 34 therebetween.

In response when the cartridge lid 7 is opened or closed, by a head release mechanism (not shown), the printing head 40 is brought to the position adjacent to the platen roller 35 via the cutting tape T and the ink ribbon R. When the cartridge lid 7 is closed, the head release mechanism brings the printing head 40 to the position abutting the platen roller 35 via the cutting tape T and the ink ribbon R. As a result, the cutting tape T(the process tape Tc) becomes available for thermal printing.

The printing feed mechanism 41 is configured to include the platen roller 35, a platen drive shaft 43, a printing feed motor 44, and a motor transfer mechanism (not shown). More in detail, the platen roller 35 is provided to the cartridge C, and is rotated by the platen drive shaft 43. The platen drive shaft 43 is rotated by the printing feed motor 44. The power transfer mechanism decelerates the power of the printing feed motor 44 using a deceleration gear string before transfer to the platen drive shaft 43. The platen drive shaft 43 is disposed to stand at the cartridge attachment section 8, and engaged with the platen roller 35 of the cartridge C that is set to the cartridge attachment section 8. When the printing feed motor 44 is turned on, the platen roller 35 starts rotating via the platen drive shaft 43 so that the cutting tape T is dispensed. At the same time, the (printed) cutting tape T is forwarded toward the full-cut unit 22 and then the cutting unit 23 along the tape feeding path 20.

Together with the platen drive shaft 43, the cartridge attachment section 8 is provided, to stand, with a ribbon take-up drive shaft 45 that is engaged with the ribbon take-up reel 33. The ribbon take-up drive shaft 45 is also receiving the power of the printing feed motor 44 via the power transfer mechanism, and the platen drive shaft 43 thus rotates in synchronization with the ribbon take-up drive shaft 45. That is, the cutting tape T is forwarded at the same time as the ink ribbon R is taken up.

Described next is the full-cut unit 22. As shown in FIG. 2, the full-cut unit 22 is configured to include a full cutter 50, a full-cut motor 51, a power transfer mechanism (not shown), and a full-cut drive mechanism 52. More specifically, the full cutter 50 is facing the tape feeding path 20, and cuts like scissors the cutting tape T directed from the printing unit 21. The power transfer mechanism transfers the power of the full-cut motor 51 to the full cutter 50. The full-cut unit 22 is also provided with a full-cut drive mechanism 52 that puts the full cutter 50 into the cutting operation (the full-cut process) through power provision thereto.

The full-cut unit 22 (the full cutter 50) is disposed adjacent to the cartridge attachment section 8 on the downstream side of the printing unit 21 in the tape feeding direction. In the full-cut process of driving the full-cut drive mechanism 52 to make the full cutter 50 cut the cutting tape T, the cutting tape T directed from the printing unit 21 is cut (fully cut) at a predetermined length.

The cutting unit 23 goes through the cutting process with respect to the cutting tape T, i.e., the tape piece, that has been cut in the full-cut unit 22. In the cutting process, only the process tape Tc is cut, in the strict sense, also a part of the peeling tape. Such a cutting process is the concept of including a so-called half-cut process in which only the process tape Tc is so cut as to cross the tape width direction of the cutting tape T.

As shown in FIG. 2, the cutting unit 23 is configured to include a cutting mechanism 60, a tape housing mechanism 62, and a path change mechanism 63. More in detail, the cutting mechanism 60 is so disposed as to face the tape feeding path 20, i.e., the first feeding path 20a, and goes through the cutting process of cutting only the process tape Tc while feeding the tape in a direction opposite to normal along the tape feeding path 20. The tape housing mechanism 62 is provided with the tape housing section 61 that is linked to the second feeding path 20b, and houses the cutting tape T coming from the direction opposite to normal due to the cutting process in such a manner that the tail end of the tape freely slide in and out. The path change mechanism 63 guides to the second feeding path 20b the tail end of the cutting tape T that has been fully cut after the cutting process.

That is, in the cutting unit 23, the tail end of the fully-cut cutting tape T is first guided to the second feeding path 20b by the path change mechanism 63. At the same time, the tail end of the cutting tape T is once housed in the tape housing mechanism 62, and the cutting tape T is directed opposite to normal on the way from the tape housing mechanism 62 to the tape ejection slot 9, i.e., at some point on the tape feeding path 20 for the cutting process.

The cutting mechanism 60 is configured to include a cutting tool 64, a tool carriage 65, a tool moving mechanism 66, a tool up-and-down mechanism 67, and a cutting feed mechanism 68. More specifically, the cutting tool 64 is so disposed as to face the first feeding path 20a on the downstream side of the second feeding path 20b, and cuts the process tape Tc. The tool carriage 65 supports the cutting tool 64 to freely move in the tape width direction. The tool moving mechanism 66 serves to reciprocate the cutting tool 64 in the tape width direction, which is orthogonal to the tape feeding direction. The tool up-and-down mechanism 67 that moves the cutting tool 64 away from the process tape Tc by moving the cutting tool 64 in the vertical direction. The cutting feed mechanism 68 directs the cutting tape T coming from the full-cut unit 22 in a direction opposite to normal along the tape feeding path 20.

The cutting tool 64 is configured by a tool 70, and a tool holder 71 that keeps hold of the tool 70 at the tip. The tool carriage 65 is supporting the tool holder 71 to be detachable therefrom. The apparatus case 4 is provided with a tool exchange lid 10 to freely open or close based on the position where the cutting tool 64 is accommodated. From the tool exchange lid 10, the cutting tool 64 can be exchanged whenever required.

The tool moving mechanism 66 is provided with a carriage moving motor 72, and a power transfer mechanism (not shown). More in detail, the carriage moving motor 72 serves as a power source for moving the cutting tool 64 via the tool carriage 65. The power transfer mechanism transfers the power of the carriage moving motor 72 to the tool carriage 65 via a deceleration gear string and a timing belt (both are not shown).

The tool up-and-down mechanism 67 is provided with an up-and-down motor 73, and by starting the motor, moves the cutting tool 64 between a cutting position and a wait position via the tool carriage 65. The process tape Tc is cut at the cutting position, and the wait position is at a distance from the process tape Tc.

The cutting feed mechanism 68 is configured to include a pair of feeding rollers 74, a cutting feed motor 75, and a power transfer mechanism that is not shown. More specifically, the feeding rollers 74 are so disposed as to sandwich the cutting tool 64 therebetween in the tape feeding. direction of the first feeding path 20a. The cutting feed motor 75 is so configured as can be rotated in two directions, i.e., a normal direction and a direction opposite to normal. The power transfer mechanism transfers the power of the cutting feed motor 75 to the pair of feeding rollers 74.

The pair of feeding rollers 74 are each configured by a grip roller, including a drive roller 76, and a follower roller (free roller) 77. The drive roller 76 is connected to the cutting feed motor 75, and the follower roller 77 is abutting the drive roller 76 via the cutting tape C, and rotates as the drive roller 76 rotates. The follower roller 77 is pivotally supported by a follower roller support frame 78 to freely rotate. The follower roller support frame 78 is incorporated with an escape mechanism (not shown) that moves the follower roller 77 between a grip position and an escape position. Here, at the grip position, the follower roller 77 is gripped by the drive roller 76, and not gripped thereby at the escape position. With such a configuration, during the printing process, moving the follower roller 77 to the escape position by driving the escape mechanism enables to appropriately secure the running path for the cutting tape T. In the present embodiment, the above-described up-and-down motor 73 serves also as a power source for driving the escape mechanism.

The cutting mechanism 60 executes the cutting process by driving in sync the components of the tool moving mechanism 66, the tool up-and-down mechanism 67, and the cutting feed mechanism 68. More in detail, during the cutting process, the tool up-and-down mechanism 67 moves the cutting tool 64 whenever needed in the vertical direction. The cutting feed mechanism 68 feeds the cutting tape T in the direction opposite to normal, and at the same time, the tool moving mechanism 66 moves (reciprocates) the cutting tool 64 in the tape width direction. In such a manner, the cutting tape T (the process tape Tr thereof) can be cut in any desired shape.

The tape housing mechanism 62 houses the tail end of the cutting tape T to make it freely slide in and out. This is aimed to protect the printing unit 21 (and the full-cut unit 22) from interference of the tail end of the cutting tape T coming from the direction opposite to normal due to the cutting process. The tape housing mechanism 62 is configured to include the tape housing section 61, a take-up drum 80, a tape biasing mechanism 81, and a power mechanism (not shown) More in detail, the tape housing section 61 is so provided as to face the cutting mechanism 60 with the first feeding path 20a therebetween, and linked to the second feeding path 20b. The take-up drum 80 is disposed in the tape housing section 61, and successively takes up the cutting tape T (tail end side) coming over the second feeding path 20b. The tape biasing mechanism 81 biases the cutting tape T forwarded to the tape housing section 61 to the take-up drum 80. The power mechanism uses the power of the cutting feed motor 75 to rotate the take-up drum 80 in the take-up direction of the cutting tape T.

The path change mechanism 63 is configured to include a path change member 82, and a path change member moving mechanism (not shown). More in detail, the path change member 82 blocks the first feeding path 20a at the portion where it is branched to the second feeding path 20b. The path change member moving mechanism is driven by a motor, and is configured to move the path change member 82 between the path change position where the first feeding path 20a is blocked, and a wait position where the first feeding path 20a is opened. Prior to the cutting process, when the tail end of the cutting tape T is directed to the tape housing mechanism 62, the path change member moving mechanism is driven to move the path change member 82 at the wait position to the path change position so that the first feeding path 20a is blocked at the branch portion. In this manner, the tail end of the cutting tape T that is directed from the first feeding path 20a toward the tape housing mechanism 62 is guided to the second feeding path 20b. Note here that the power of the up-and-down motor 73 is transferred also to the path change member moving mechanism via the power transfer mechanism, and thus the path change member moving mechanism moves the path change member 82 in synchronization with the escape mechanism. That is, with the operation of the escape mechanism, when the feeding roller 74 is put into the non-grip state, the path change member 82 is located at the wait position, and is located at the path change position when the feeding roller 74 is put into the grip state.

The control unit 24 is connected to the components of the tape processing apparatus 1, and exercises collective control thereover.

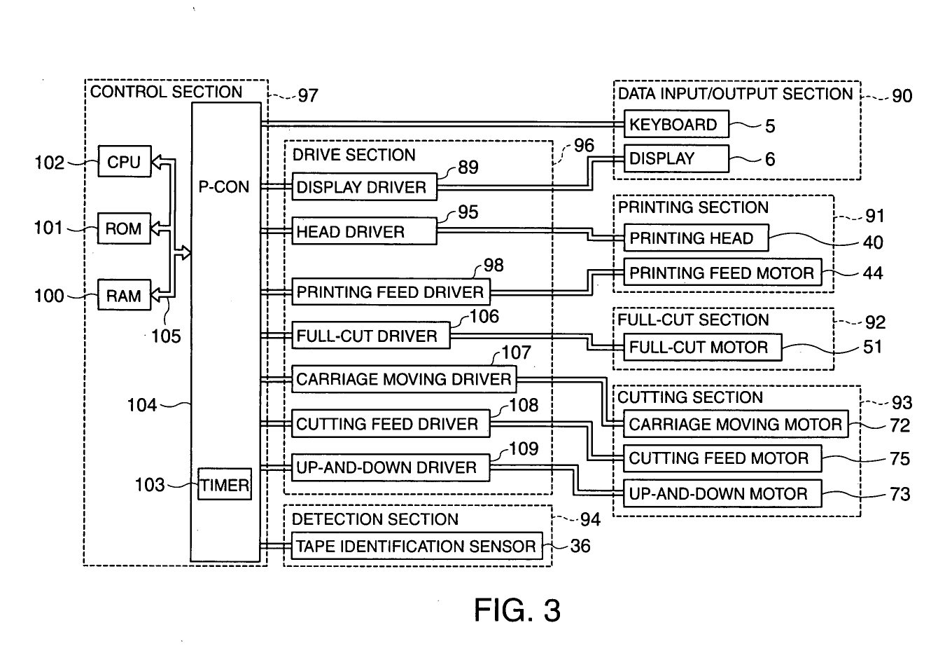

Described next is the main control system of the tape processing apparatus 1. As shown in FIG. 3, the tape processing apparatus 1 is configured to include a data input/output section 90, a printing section 91, a full-cut section 92, a cutting section 93, a detection section 94, a drive section 96, and a control section 97. More specifically, the data input/output section 90 is provided with the keyboard 5, the display 6, and others, and serves to input/output various information and commands for use in the printing process and the cutting process. The printing section 91 is provided with the printing head 40 and the printing feed motor 44, and subjects the cutting tape T to the printing process by driving the printing head 40 in synchronization with the printing feed motor 44. The full-cut section 92 is provided with a full-cut motor 51, and subjects the printed cutting tape T to the full-cut process. The cutting section 93 is provided with an up-and-down motor 73, a cutting feed motor 75, and a carriage moving motor 72, and through synchronous driving of these components, subjects the full-cut cutting tape T to the cutting process. The detection section 94 is provided with various sensors including the tape identification sensor 36, and takes charge of various detections. The drive section 96 is provided with various drivers, and drives the components. The drivers include a head driver 95 that drives the printing head 40, a motor driver that drives the motors, and others. The control section 97 is connected to such components, and exercises control over the tape processing apparatus 1 in its entirety.

The control section 97 is configured to include RAM 100, ROM 101, a CPU 102, a peripheral control circuit (P-CON) 104, and a bus 105. More in detail, the RAM 100 includes a recording region that is available for temporary storage, and is used as a working area for a control process. The ROM 101 includes various storage areas, and stores a control program and control data, e.g., a color conversion table, a letter ornament table, and others. The CPU 102 applies a computation process to various data. The P-CON 104 includes a logic circuit for handling interface signals with other peripheral circuits, and a timer 103 for time control application. The bus 105 is provided for connection of such components.

The control section 97 makes the CPU 102 go through a computation process in accordance with the control program or others stored in the ROM 101 with respect to various data provided by the components through the P-CON 104, and various data in the RAM 100. The process result, i.e., a control signal, is output to the various drivers through the P-CON 104 so that the components are accordingly put under the control thereof.

The tape processing apparatus 1 of the present embodiment can apply, to the cutting tape T, the printing process of printing a character, and the clip-out process of clipping out the character along the outline thereof. For character input, the tape processing apparatus 1 is provided with two types of input mode, i.e., “printing input mode”, and “clipping input mode”. In the printing input mode, a character input is made for the printing process, and in the clipping input mode, a character input is made for the clip-out process. Described here is the character input procedure for the clip-out process.

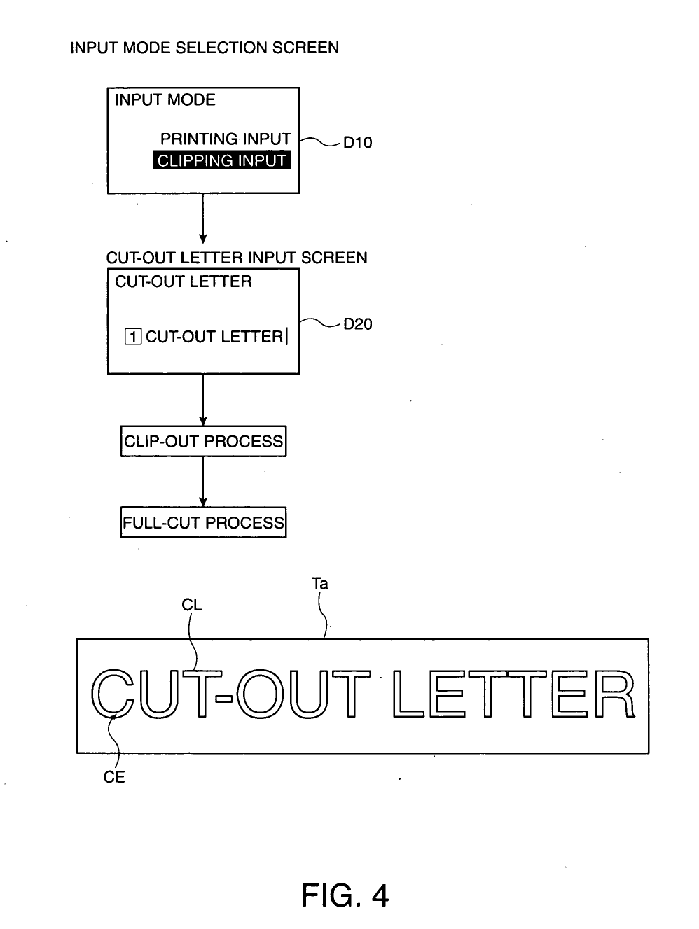

As shown in FIG. 4, a user displays an input mode selection screen D10 through a predetermined key operation using the keyboard 5. The user then makes a setting to the “clipping input mode” on the displayed input mode selection screen D10. Next, on a cut-out letter input screen D20, the user makes an input of “cut-out letter”, for example. Thereafter, in response to the user's predetermined key operation using the keyboard 5 as a trigger, the tape processing apparatus 1, i.e., the cutting section 93, executes the clip-out process of clipping out each character of “cut-out letter” along their outlines. After both the process tape Tc and the peeling tape Tp are fully cut, the tape ejection port 9 ejects the resulting full-cut tape piece Ta, which is shown in the lower part of FIG. 4. In the tape piece Ta, cut-out lines CL are formed along the outlines of the characters. The user may peeling clip-out regions CE from the peeling tape Tp for attachment to glasses or others for decoration or POP use.

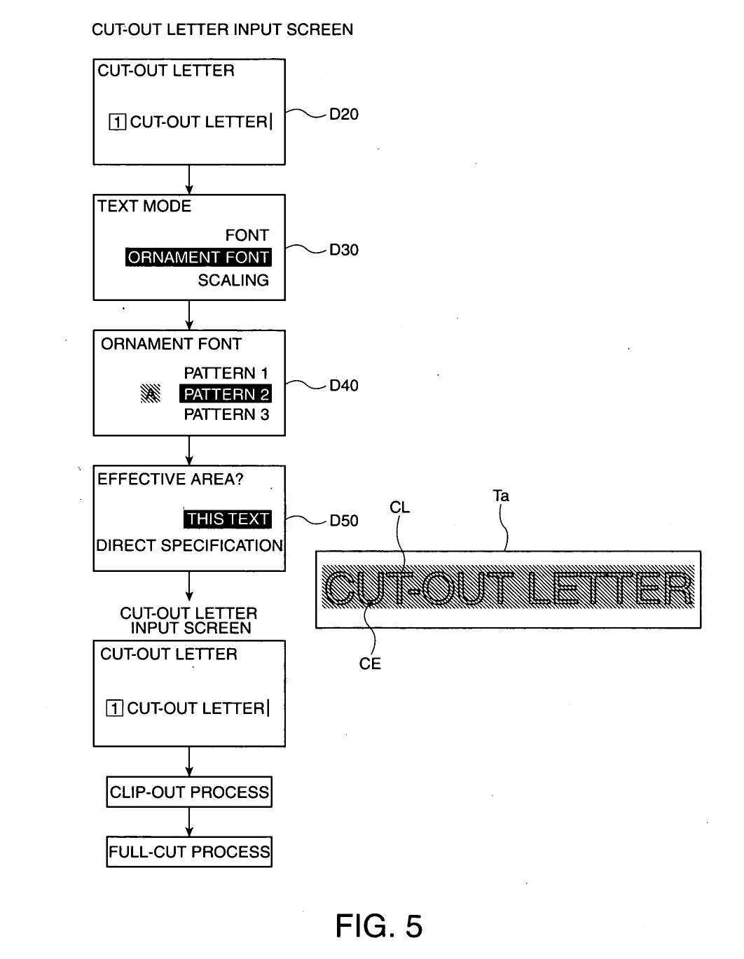

The tape processing apparatus 1 of the present embodiment is capable of printing the clip-out regions CE of the characters with a pattern for decoration purpose. Described here is the operation procedure of printing the clip-out regions CE with a pattern. As shown in FIG. 5, the user first makes an input of “cut-out letter”, for example, on the cut-out letter input screen D20. Through the user's key operation using the keyboard 5, a text mode menu screen D30 appears. This text mode menu is for various settings for the character input by the user, e.g., printing (clipping) direction, font, ornament font, scaling, or spacing.

With the clipping input mode, a value set on the text mode menu screen D30 is applied to the character that has been input as a clip-out target. In response to a selection of “ornament font” made on the text mode menu screen D30, an ornament font menu screen D40 appears. When the user wants to print a pattern to the clip-out regions CE of the characters for clipping, the ornament font menu screen D40 is used for any required settings for the purpose. In the tape processing apparatus 1 of the present embodiment, the ROM 101 previously stores a plurality of pattern forms for printing. Accordingly, the ornament font menu screen D40 displays pattern forms available for printing, e.g., “pattern 1”, “pattern 2”, “pattern 3” in the drawing.

In the ornament font menu screen D40, an image of the selected pattern is overlaid on the characters for image display at the left portion of the screen. This allows the user, even if he or she has no idea what pattern forms are available, to select a pattern form whichever he or she prefers while looking at the image display on the ornament font menu screen D40. After the user selects a specific pattern form, i.e., “pattern 2” in the drawing, an area specification screen D50 appears for area specification of pattern printing. The area specification screen D50 of this example displays two selection options of “this text” and “direct specification” so that the user selects an area specification method whichever he or she wants, i.e., “this text” in the drawing. Herein, “this text” means pattern printing to the clip-out region CE of every input character, and “direct specification” means to leave area specification to a user.

After the area is specified for pattern printing, the cut-out letter input screen D20 appears again. In response to the user's predetermined key operation using the keyboard 5 as a trigger, the tape processing apparatus 1, i.e., the printing section 91, executes a pattern printing process with respect to the clip-out regions CE, and the clip-out process of clipping the characters of “cut-out letter”. After both the process tape Tc and the peeling tape Tp are fully cut, the tape ejection slot 9 ejects the resulting full-cut tape piece Ta, which is shown in the right portion of FIG. 5.

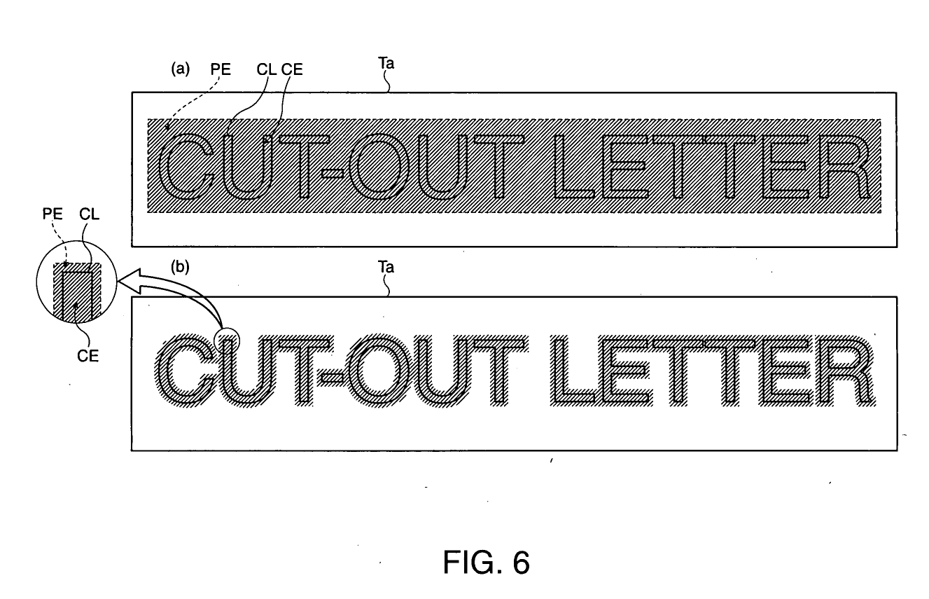

Here, a printing region PE to be printed with a pattern is described by referring to FIGS. 6A and 6B. As shown in the drawings, the tape processing apparatus 1 of the present embodiment sets a clip-out region CE based on the character input as a clip-out target. The-tape processing apparatus 1 also sets a printing region PE based on the clip-out region CE that has been set. The printing region PE is not exactly the same as the clip-out region CE but goes beyond the edge of the clip-out region CE. That is, the pattern is so printed as to go beyond the cut line CL of the input character.

With this being the case, as shown in FIG. 6A, the printing region PE may be of a single region, including the input character with margins therearound. Alternatively, as shown in FIG. 6B, the printing region PE may be so set as to be located along the cut line CL of each of the characters. For example, data about the cut line of a character may be subjected to a side widening process, and a region one size larger than the cut line CL of the character is set as a printing region PE before pattern printing. As such, because the pattern is so printed as to go beyond the cut line CL of the input character, even if some displacement is observed between the region printed by the printing section 91 and the region to be clipped out by the cutting section 93, the clip-out region CE can be entirely printed with a pattern.

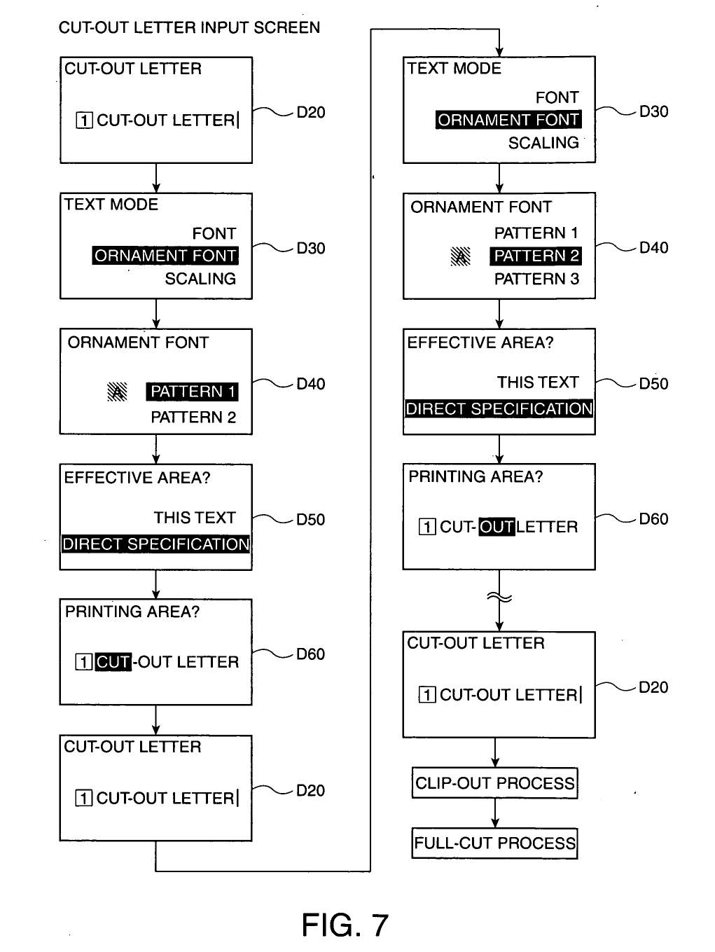

It is also possible to specify a pattern form for every character that has been input as a clip-out target. With this being the case, as shown in FIG. 7, the user first makes an input of “cut-out letter” on the cut-out letter input screen D20, for example. In response to the user's key operation using the keyboard 5, the text mode menu screen D30 appears. When the user selects “ornament font” on the text mode menu screen D30, the ornament font menu screen D40 is displayed. When the user selects any specific pattern form on the ornament font menu screen D40, i.e., “pattern 1” in the drawing, the area specification screen D50 appears for area specification of pattern printing. On the area specification screen D50, exemplified here is a case where “direct specification” is selected.

When “direct specification” is selected on the area specification screen D50, a direct specification screen D60 appears, asking for direct specification of an area for pattern printing. On the direct specification screen D60, the user specifies an area for printing the pattern (pattern 1) selected on the ornament font menu screen D40 through predetermined key operation. Herein, a character(s) in the specified area are displayed on the screen in reverse color, e.g., the first two characters are specified as the printing area in the drawing. After such area specification is through, the cut-out letter input screen D20 appears again. Through similar key operations, the text mode menu screen D30 is displayed, and then the ornament font menu screen D40 for selection of “pattern 2” this time.

Thereafter, on the area specification screen D50, “direct specification” is selected, and on the direct specification screen D60, an area for pattern (pattern 2) printing is specified by predetermined key operation, e.g., the middle two characters are specified as the printing area in the drawing. Through similar key operation, “pattern 3” is selected (not shown) for a pattern form for printing to the input characters (the last two characters). By specifying a pattern form for every input character with such a procedure, the resulting tape piece Ta looks like as shown in FIG. BA. That is, the clip-out region CE on the same tape piece Ta can be printed with each different patterns so that the result will be immensely rich in variety.

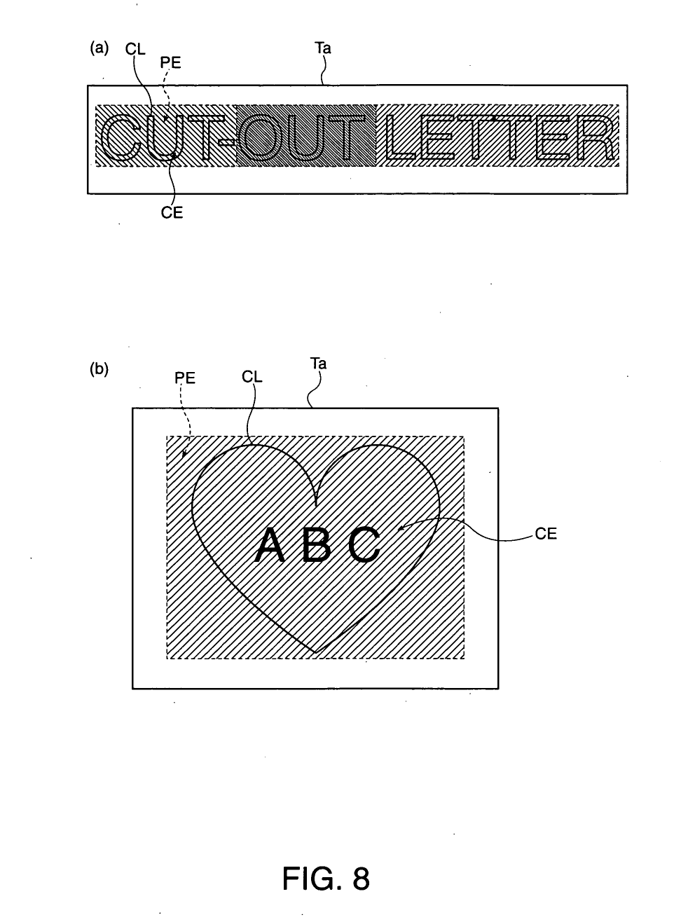

Herein, the input characters as clip-out targets are not restrictive to letters, and may be symbols and graphics. A pattern may be printed on any printed character. For example, as shown in FIGS. 8A and 8B, if a user wants to clip out a printing target character of “ABC” in the shape of a “heart”, the area enclosed by the “heart” character will be the clip-out region CE. When the clip-out region CE is printed with a pattern, the printing region PE is so set as to go beyond the cut line CL in the shape of “heart” so that the pattern is printed.

In the present embodiment, exemplified is a case of making an input of clip-out target character in the “clipping input mode”. This is surely not the only option. For example, in the “printing input mode”, of making an input of printing target character, a clipping feature may be provided as a part of special printing.

The components (functions) of the tape processing apparatus 1 of the above example may be provided as a program. If this is the case, the program may be stored in a recording medium (not shown) for distribution. The recording medium includes CD-ROMs, flash ROMs, memory cards (compact flash™, smart media, and memory sticks), compact disks, magneto-optical disks, digital versatile disks, flexible disks, and others.

While the embodiment has been described in detail, it is understood that numerous other modifications and variations can be devised for configuration and processes of the tape processing apparatus 1 without departing from the scope of the invention.

What is claimed is:

1. A sheet processing apparatus that applies a clip-out process of clipping out a desired character from a process sheet that configures a cutting sheet with a peeling sheet attached on a rear side, and a printing process of printing a pattern to a clip-out region of a clipping as a result of the clip-out process, the sheet processing apparatus comprising:
a clip-out device that clips out the character from the process sheet of the cutting sheet while feeding the cutting sheet in a direction opposite to normal based on the character; and
a printing device that prints a pattern to the clip-out region of the character that is clipped out from the process sheet, wherein
the printing device prints the pattern to make the pattern go beyond a cutting line of the character.

2. The sheet processing apparatus according to claim 1, wherein
the printing device can print the pattern in various pattern forms, and
the sheet processing apparatus further includes a pattern form specification device that specifies the pattern by form for printing.

3. The sheet processing apparatus according to claim 2, wherein
the pattern form specification device can make the specification on the basis of the character.

4. A sheet processing method for implementing a sheet processing apparatus that applies a clip-out process of clipping out a desired character from a process sheet that configures a cutting sheet with a peeling sheet attached on a rear side, and a printing process of printing a pattern to a clip-out region of a clipping as a result of the clip-out process, the sheet processing method comprising:
clipping out the character from the process sheet of the cutting sheet while feeding the cutting sheet in a direction opposite to normal based on the character; and
printing a pattern to the clip-out region of the character that is clipped out from the process sheet to make the pattern go beyond a cutting line of the character.

5. A program for use with a computer and being operable to instruct the computer to serve as the units in the sheet processing apparatus of claim 1.
